(19) United States
(12) Patent Application Publication
(10) Pub. No.: US 2009/0301220 A1
(43) Pub. Date: Dec. 10, 2009

(54) DEVICE FOR MEASURING A MASS FLOW

(75) Inventors: Steven Smets, Kontich (BE); Philippe Jans, Lier (BE)

Correspondence Address: SUGHRUE MION, PLLC, 2100 PENNSYLVANIA AVENUE, N.W., SUITE 800, WASHINGTON, DC, 20037, US

(73) Assignee: KATOEN NATIE, Antwerpen (BE)

(21) Appl. No.: 12/300,242

(22) PCT Filed: May 10, 2006
(86) PCT No.: PCT/EP2006/062222

§ 371 Date: Jul. 13, 2009

(51) Int. Cl. G01F 1/76

(52) U.S. Cl. 73/861.351

(57) ABSTRACT

The present invention relates to a mass flow meter (1) for measuring the mass flow of a material supply flow of fluent particles. The mass flow meter (1) comprises means (2) for receiving the material supply flow, material conducting means (4) for conducting the material supply flow from the receiving means (2) towards an outlet (6) for discarding the material, wherein the material conducting means (4) comprise at least one guiding unit (9) for conducting the material flow through the mass flow meter (1) along at least one flow direction (8), wherein the at least one guiding unit (9) comprises at least one measuring unit (20) with a measuring surface (15) comprising velocity measuring means (10) for determining a velocity with which the material flow is flowing over the measuring surface (15) from an upper part towards a lower part of the measuring surface (15) and force measuring means (5) for determining a force exerted by the material flow to the measuring surface (15) when flowing over the measuring surface (15). The velocity measuring means (10) comprise at least a first and a second sensor placed at a distance (17) from each other in flow direction (8) of the material, the first (11) and second sensor (12) each being provided for gathering data on electrostatic charge of the material flow, as a function of time. The mass flow meter (1) comprises a processor for converting the data on the electrostatic charge as a function of time to an output signal representing the velocity with which the material flow is flowing over the measuring surface (15).

The present invention relates to a mass flow meter for measuring the mass flow of a material supply flow of fluent particles, the mass flow meter comprising
means for receiving the material supply flow and
material conducting means for conducting the material supply flow from the receiving means towards an outlet for discarding the material, wherein the material conducting means comprise at least one guiding unit having a width for conducting the material flow through the mass flow meter along at least one flow direction, wherein the at least one guiding unit comprises at least one measuring unit with a measuring surface having a mean slope in relation to a horizontal and comprising velocity measuring means for determining a velocity with which the material flow is flowing over the measuring surface from an upper part towards a lower part of the measuring surface and force measuring means for determining a force exerted by the material flow to the measuring surface when flowing over the measuring surface,
the mass flow meter further comprising a processor for calculating the mass flow by processing the determined material velocities and forces.

Such a mass flow meter is known from EP-A2-1.205.737. EP-A2-1.205.737 discloses arrangements at an apparatus for measuring the mass flow of a material supply flow of fluent particles, by determining both the velocity with which the material flow is displaced over a measuring surface and the forces exerted by the material flow onto the measuring surface, per unit length of the surface. The measured force is representative for the weight of the material per unit length of the measuring surface, and the velocity is representative for the mean velocity with which the material is moving over the unit length of measuring surface. The velocity is measured by an optical measuring device comprising a light source, which emits a light beam to the material supply flow. The light reflected by the material flow of fluent particles against an array of photo detecting cells produces a signal, which is representative of a speckle pattern created by reflection of the light reflected on the particulate material. The optical measuring means are positioned on a location where the velocity of the material supply flow of fluent particles reaches the mean velocity of the material supply flow of fluent particles. The signal is processed by a calculator to an output signal which represents the velocity or travel speed of the material. The thus calculated velocity is then further combined with the weight of the material per unit length to obtain the mass flow of the material.

The mass flow meter disclosed in EP-A2-1.205.737 however has the disadvantage that the measurement of the mass flow of the material supply flow of fluent particles is insufficiently accurate, and often gives rise to a substantial shortage or surplus in the total mass processed by the mass flow meter compared to the mass predicted by the mass flow meter. There is thus a need for a mass flow meter with which the mass flow of a material supply flow of fluent particles can be determined with an improved accuracy.

Accordingly, it is the object of the present invention to provide a mass flow meter which permits determining a mass flow of a material supply flow of fluent particles with an improved accuracy.

This is achieved according to the present invention with a mass flow meter showing the technical features of the characterising portion of the first claim.

Thereto, the mass flow meter of the present invention is characterised in that
the means for determining the velocity of the flow of fluent material comprise at least a first and a second sensor placed at a distance from each other in flow direction of the material, the first and second sensor each being provided for gathering data on electrostatic charge of the material flowing, as a function of time,
the mass flow meter comprising a processor for converting the data on the electrostatic charge as a function of time to an output signal representing the velocity with which the material flow is flowing over the measuring surface.

The inventor has found that by measuring the electrostatic charge of the material flowing over the sensors as a function of time, the material flow speed can be determined with an improved accuracy. The measurement of the electrostatic charge of the mass flowing over the sensors permits not only determining the speed of the bottom material layer which is in direct contact with the measuring surface, but also of the material layers located on top of that first layer. The electrostatic charge measured by the sensors is namely not limited to the material layer that is directly flowing over the measuring surface, but includes a portion of an electrostatic charge of layers present on top of the bottom layer. In particular, the electrostatic charge is inversely proportional to the square of the distance to that electrostatic charge. As a consequence, the sensors will also measure the electrostatic charge provided by material layers present on top of the bottom layer. Besides that, the material of the bottom layer may travel over the measuring surface with a different velocity as compared to material layers located on top of it. The measurement of the electrostatic charge takes account of this difference and thus permits an improved measurement of the velocity of the total material supply flow.

In that respect it is remarked that an analysis of the problems occurring with the prior art device revealed that the detector surface of the optical sensor shows a serious risk of getting partially or wholly covered by the material particles. Some materials have been found capable of even permanently damaging the detector surface of the sensor. Both parameters contribute to distorting the optical measurements and thus the calculation of the velocity of the material supply flow. Electrostatic charge sensors have been found to be more sturdy and less sensitive to damages induced by the material flow, so that no corrections need to be done for that and the material flow velocity can be calculated with an improved accuracy. Besides that, electrostatic sensors have been found suitable for use with a broader spectrum of materials (dimensions, shape, chemical composition, optical properties . . . ) as compared to optical sensors.

The present invention presents the additional advantage that a more accurate determination of the velocity is obtained, since the velocity of the flow of fluent material is measured using at least a first and a second sensor positioned at a distance from each other in flow direction of the material, the determination of the velocity thus being based on two distinct measurements conducted on two distinct locations.

The contribution of the inevitable frictional forces to the force exerted by the material particles to the measuring surface, whereby the frictional forces act on the fluent particles in a direction parallel to the measuring surface, may be minimised by providing the force measuring means which are capable of determining a component of the force exerted onto the measuring surface which extends perpendicular to the mean slope of the measuring surface.

In another preferred embodiment of this invention the at least one measuring surface is curved in the flow direction of the material. Preferably the measuring surface is concave. More preferably, the at least one measuring surface has an arcuate shape with a virtually constant radius in the flow direction of the material. The inventors have found that the use of a measuring surface which is curved in the flow direction of the material permits further improving the accuracy of the mass flow measurement. If it is desired to further improve the accuracy of the mass flow measurement to take account of the dimensions of the fluent particles, varying physical characteristics of the measuring environment and/or changes in the composition of the material, the mass flow meter may comprise means for adjusting the mean slope of the measuring surface.

In a further preferred embodiment the mass flow meter according to the invention comprises means for accurately determining the mean slope of the measuring surface thus adding to the accuracy of the determined mass flow of the flow of fluent particles.

In a further more preferred embodiment of this invention the measuring units are positioned symmetrical with respect to the material receiving means. To improve the uniformity of the material flow and improve the accuracy of the measurements, the mass flow meter preferably comprises multiple guiding units which are substantially identical and which divide the material flow of the fluent particles in several flows and flow directions, one flow direction per guiding unit. The inventors have found that by constructing a mass flow meter according to these embodiments, fluctuations in the mean slope can be accounted for, thus adding to the accuracy of the measurement.

The accuracy of the electrostatic charge measurement and thus the material velocity may be further improved by providing material conducting means comprising means for uniformly distributing the material flow over the full width of the guiding unit. Optimum electrostatic charge measurement results are obtained if the measurement can be performed on the basis of a homogenous distribution with optimal thickness in which the speed of the particles is homogenously distributed.

In another preferred embodiment of this invention the means for receiving the material supply flow comprise means for controlling the material supply flow. The presence of material supply flow controlling means permits controlling the in-flow of the fluent particles, which in turn permits optimising the spreading of the material flow over the measuring surface and improving the accuracy of the measurement of the mass flow of the fluent particles. The material supply flow controlling means used in the present invention may be any means known to the person skilled in the art, but preferably comprise a plurality of slideable plates which, when slid together, decrease the mass flow of the fluent particles and which, when slid away from each other, increase the mass flow of the fluent particles.

If so desired, at least three sensors are provided in the measuring surface and the acceleration of the fluent particles over the measuring surface is measured. The measured acceleration can be used for a more accurate determination of the mass flow.

The invention also relates to a process for measuring the mass flow of a material supply flow of fluent particles. Thereto, the material supply flow is provided to the above described mass flow meter, the fluent particles flow along material conducting means comprising at least one guiding unit for guiding the flow of fluent particles along at least one flow direction over a measuring surface along a measuring unit towards an outlet, wherein the velocity with which the material flow of the fluent particles flows over the measuring surface is measured as well as the force exerted by the material flow to the measuring surface, whereafter the determined velocities and forces are processed in order to calculate the mass flow of the fluent particles. The method of this invention is characterised in that the velocity is determined by gathering data on the electrostatic charge of the material flow as a function of time and in that the data on the electrostatic charge as a function of time is converted to a signal representing the velocity with which the material flow is flowing over the measuring surface.

The invention is further elucidated in the figures attached to the present application and the figure description below.

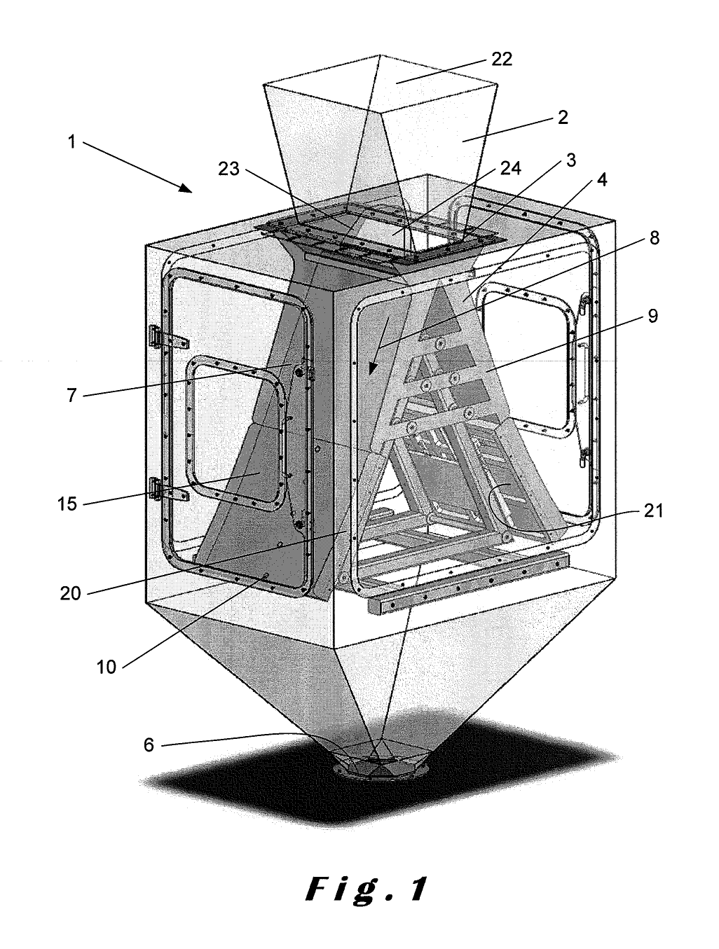

FIG. 1 shows a preferred embodiment of a mass flow meter according to the invention.

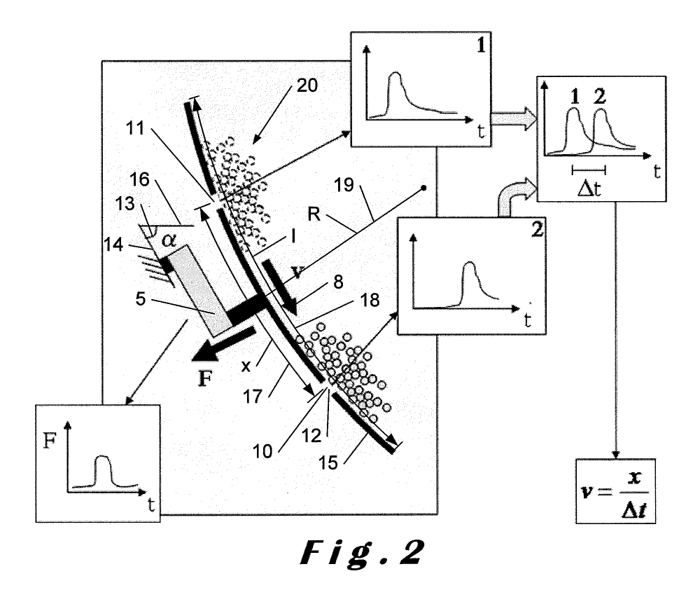

FIG. 2 schematically shows the physical considerations for determining the mass flow of the material supply flow of fluent particles.

The preferred embodiment of the mass flow meter 1 as shown in FIG. 1 comprises means 2 for receiving the flow of fluent particles. These means 2 comprise a top opening 22 for receiving the flow of fluent particles and a bottom opening 23 comprising an inlet 24 guiding the flow of fluent particles to material conducting means 4. The conducting means 4 guide the flow of fluent particles to an outlet 6. The mass flow meter 1 according to this embodiment receives the flow of fluent particles by the receiving means 2 and guides the fluent particles in a downward direction towards the outlet 6 over the conducting means 4 along at least one flow direction 8.

When flowing over the conducting means 4, the fluent particles form a layer of fluent particles having a thickness of at least one layer of fluent particles.

The means 2 for receiving the material flow of fluent particles can receive the flow of fluent particles for example from a process using fluent particles, from a storage silo, from any sort of suitable storage facility for the fluent particles or from any other application deemed appropriate by the person skilled in the art. The receiving means 2 can be permanently or removably mounted to the application providing the flow of fluent particles. The shape of the receiving means 2 is not critical to the invention and can have any shape deemed appropriate to the person skilled in the art.

The receiving means 2 preferably comprise a flow controller for controlling the material supply flow by adjusting, i.e. increasing or decreasing, the material supply flow. Preferably, the flow controller is positioned at the inlet 24 of the flow of fluent particles to the conducting means 4 but its position is not critical to the invention as long as a representative part of the material flow is received through the flow controller. Any flow controller considered suitable by a person skilled in the art can be used, but preferably co-operating slideable plates 3 are used. The plates 3 are preferably slideably in such a way that the dimensions of the inlet 24 may be increased or reduced, to adjust the flow that is fed to the mass flow meter. Sliding the slideable plates 3 to at least partially cover the inlet 24 to create a smaller opening for the fluent particles to flow through, causes the flow of the fluent particles to the conducting means 4 to decrease. Inversely, when the slideable plates 3 are slid open to create a larger inlet 24 for the fluent particles, the flow rate increases. The number and shape of the slideable plates 3 are not critical to the invention and can be determined by the person skilled in the art.

Downstream of the means 2 for receiving the material supply flow, the mass flow meter 1 comprises material conducting means 4. The material conducting means 4 can be made of plastic or any other material found suitable to the person skilled in the art, but preferably they are made of metal. The material conducting means 4 guide the flow of fluent particles along at least one flow direction 8. Thereto, along each flow direction 8, the material conducting means 4 preferably comprise at least one guiding unit 9 having a width for guiding the flow of fluent particles over its surface.

The guiding unit 9 preferably comprises means 7, more preferably a material flow spreader 7, for evenly distributing the flow of fluent particles in width direction over the surface of the guiding unit 9 in order to minimise differences in thickness of the layer of the fluent particles flow, thus adding to homogeneity of the layer of the fluent particles and to the accuracy of the mass flow measurement. The material flow spreader 7 comprised in the guiding unit 9 functions to stabilise the turbulent particles flow leaving the receiving means 2. Preferably, the flow of fluent particles is spread open by the material flow spreader 7 in view of homogeneously distributing the particles into a layer with a thickness which is optimal for determining the mass flow. Thereto, the width of the guiding unit 9 and the opening created by the flow controller can be adjusted by the person skilled in the art. Preferably, the material flow spreader 7 extends from the inlet 24 and guides the particles flow along the flow direction 8. Preferably, the material flow spreader 7 comprises a flat plate having a length over which the fluent particles flow. The guiding unit 9 can however also comprise other flow spreading means 7 found suitable by the person skilled in the art, for spreading the particle flow over the width of the surface of the guiding unit 9. The length of the plate forming the flow spreading means, needed to obtain a homogeneous flow can be determined by the person skilled in the art.

Downstream the material flow spreader 7, the mass flow meter 1 comprises at least one measuring unit 20. Preferably, the mass flow meter 1 comprises at least one measuring unit 20, but the number of measuring units 20 is not critical to the invention and can be suitably adapted by the person skilled in the art. The measuring unit 20 comprises a measuring surface 15 which has a mean slope 13 in relation to a horizontal 16 and a length 18. The measuring surface 15 can be flat but according to a preferred embodiment of the invention is curved, preferably concave (hollow) in the flow direction 8 of the fluent particles. The measuring surface 15 further comprises velocity 10 and force 5 measuring means.

Preferably, the upper part of the measuring surface 15 connects to the bottom region of the material spreader 7 so that the layer of fluent particles is guided undisturbed to the measuring surface 15 and the homogeneity of the layer of fluent particles is not disturbed thus creating optimal measuring conditions for the measuring unit 20.

In a preferred embodiment of the invention, the velocity measuring means 10 measure the mean velocity v of the fluent particles while flowing over the length l of the measuring surface 15. In a more preferred embodiment, the measuring surface 15 is curved by a constant radius R and has a mean slope 13 α of an average plane 14 representing the measuring surface 15 with relation to the horizontal 16. Preferably, the fluent particles flow on the hollow side of the curved measuring surface 15. In the most preferred embodiment, the force measuring means 5 measure the mean perpendicular force F exerted by the flow of fluent particles onto the measuring surface 15.

In a preferred embodiment, the mass flow \dot{m} can be determined according to the following formula:

$$\dot{m} = \frac{F}{\frac{I \cdot v}{R} + \frac{I \cdot g \cdot cos ( α )}{v}} \qquad ( 1 )$$

where g represents the gravitational acceleration. However, any other relation for determining the mass flow of the mass flow meter according to the invention can be used.

In the aforementioned relation, the denominator comprises the addition of two fractions. The first fraction

$$\frac{I \cdot v}{R}$$

is derived from the forced arcuate movement of the fluent particles while the second fraction

$$\frac{I \cdot g \cdot cos ( α )}{v}$$

is derived from the sloped motion of the fluent particles in the gravitational field.

When radius R is chosen so that the first fraction and the second fraction are of the same order of magnitude, inevitable inaccuracies in the velocity v will be buffered since the velocity v occurs in the nominator of the first fraction, whereas in the second fraction, the velocity occurs in the denominator. This way, the accuracy of the mass flow \dot{m} will be substantially improved.

When measuring the mean force F perpendicularly to the measuring surface 15, the mean force F is not disturbed by frictional forces of the fluent particles caused by the movement of the fluent particles onto the measuring surface 15 since the frictional forces are perpendicular to the force F which is measured by the force measuring means 5. The frictional forces thus do not interfere with the measured force F nor with the to be determined mass flow \dot{m}. The measured force F is thus only dependent from the mass m of the flow fluent particles present on the measuring surface 15 and not from other physical characteristics.

Since the mean velocity v is constantly measured, changes in the velocity v due to different types of material, different physical characteristics of the measuring environment and/or changes in the composition of the material causing variable physical characteristics are taken into account when determining the mass flow \dot{m} of the material supply flow of fluent particles.

The position of the force measuring means 5 on the measuring surface 15 can be determined by the person skilled in the art and is not critical to the invention. However, in case multiple force measuring means 5 are present, they are evenly distributed over the measuring surface 15. Increasing the number of force measuring means improves the accuracy of the measurement of the mass flow. Preferably, the measuring surface 15 is seamlessly integrated with the remainder of the guiding unit 9, thus minimally disturbing the preferred one-layered homogeneous flow of fluent particles.

The mass flow meter 1 of this invention preferably comprises means 21 for adjusting the mean slope 13 so that the mean slope 13 of the measuring surface 15 can be adjusted in function of the physical characteristics (dimensions, shape . . . ) of the fluent particles so that an optimal flow of fluent particles can be achieved, therefore improving the accuracy of the measurement of the mass flow of the fluent particles. The adjustable mean slope 13 also allows that inaccuracies in the mounting of the mean slope 13 can be compensated so that the accuracy of the measurement of the mass flow is further improved.

The velocity measuring means 10 preferably comprise at least a first 11 electrostatic sensor and a second 12 electrostatic sensor downstream of the first 11 sensor in the flow direction 8 of the particles, for detecting the electrostatic charge of the particles flowing over the measuring surface 15. The first 11 and the second 12 electrostatic sensor are positioned on a distance x from each other in the flow direction 8 of the fluent particles.

Preferably, the first 11 and second 12 sensor are seamlessly integrated in the measuring surface 15 so that the flow of fluent particles is not disturbed by the sensors and an optimal measurement of the electrostatic charge is obtained so that the accuracy of the measurement of the mass flow of the fluent particles is further improved.

The first 11 and second 12 electrostatic sensor record the electrostatic charge of the fluent particles flowing over it as a function of time as shown in parts 1 and 2 of FIG. 2. The electrostatic charge amongst other things originates from friction of the fluent particles amongst each other and from friction of the fluent particles against the material conducting means 4. Since the electrostatic charge of the fluent particles generally remains stable, the second electrostatic sensor 12 generally records the same electrostatic distribution of the charge of the fluent particles as the first electrostatic sensor 11 as a function of time, only shifted over a period of time Δt as shown in FIG. 2. The period of time Δt is the time needed for the fluent particles to travel from the first sensor 11 to the second sensor 12. The velocity v can now be determined by dividing the distance x between the sensors by the time Δt needed for the fluent particles to travel from the first 11 sensor to the second 12 sensor as shown in FIG. 2.

The electrostatic sensors 11, 12 preferably are positioned so that the velocity v, which is determined based on the measured electrostatic charge of the fluent particles as a function of time, represents the mean velocity over the length l of the measuring surface 15.

Preferably, the length x and l are nearly the same, more preferably the first 11 and second 12 electrostatic sensor are located at the upper and lower part of the measuring surface 15 thus adding to the accuracy of the measured velocity and thus to the overall accuracy of the measurement of the mass flow. If so desired, more than two electrostatic sensors 11, 12, for example three, four or five may be provided, to improve the accuracy of the velocity measurement. The precise number of electrostatic sensors can however be determined by the person skilled in the art. When at least three electrostatic sensors are provided in the measuring surface 15, the acceleration of the fluent particles over the measuring surface 15 can be determined, based on which a more accurate value for the particles mass flow may be determined.

The measuring unit 20 comprises a processor which converts the signal of the electrostatic sensors 11, 12 representing the electrostatic charge distribution of the flow of fluent particles into a signal representing the velocity v of the flow of fluent particles. The measuring unit 20 further comprises a calculator for determining the mass flow \dot{m} of the flow of fluent particles by combining the signal representing the velocity v with a signal from the force measuring means 5 representing the force F according to the preferred aforementioned relation. The thus determined mass flow can then be fed to an external computer or can be directly visualised. Preferably, the mass flow meter 1 comprises means for determining the total mass flown through the mass flow meter 1 and means for feeding this result to an external computer or to means provided for visualising.

In a preferred embodiment of the invention, the material conducting means 4 comprise two guiding units 9 positioned on opposite sides of the material receiving means 2, and pointing in opposite directions therefrom. In case more than two guiding units 9 are present, they may be arranged circumferentially around the material receiving means 2. This arrangement permits optimum correction of inaccuracies of the mean slope α 13 due to irregularities in the mounting of the mass flow meter 1 and thus provides a more accurate determination of the mass flow of the fluent particles. The guiding unit 9 and measuring units 20 may be different, but preferably are substantially identical to each other and divide the material flow of the fluent particles in several flow directions 8, one flow direction 8 per guiding unit 9.

After having left the measuring surface, the flow of fluent particles flows to an output 6 opening where it can be collected in for example a storage volume of for example a truck, a storage silo or any other storage facility or can be fed to any other application deemed appropriate by the person skilled in the art. The location, form and size of the output opening is not critical to the invention and can the determined by the person skilled in the art.

If it is desired to further improve the mass flow measurement, the mass flow meter comprises means for accurately determining the mean slope α 13, to permit variations in the mean slope 13 of the measuring surface 15 to be taken into account in formula 1 to further improve the accuracy of the mass flow measurement. Preferably however a combination is used of means 13 for determining the mean slope α and the adjacent circumferential mounting of the guiding units 9 around the material receiving means 2. This way an increased accuracy is achieved for the determined mass flow for the flow of fluent particles.

The interior of the mass flow meter 1 according to the invention is preferably accessible, for example through side-openings closed by doors.

Preferably, the mass flow meter 1 comprises means, preferably made out of glass or acrylic glass, for viewing the flow of the fluent particles over the material conducting means 4.

The present invention also relates to a process for measuring the mass flow of a material supply flow of fluent particles. According to that process a material supply flow is provided to the above-described mass flow meter 1, in particular to the material receiving means 2 which guide the flow of the fluent particles to material conducting means 4. The conducting means 4 comprise at least one guiding unit 9 for guiding the flow of fluent particles along at least one flow direction 8 over a measuring surface 15 comprised in the guiding unit 9 towards an outlet 6. While flowing over the measuring surface 15, a measuring unit 20 determines the velocity with which the material flow of the fluent particles flows over the measuring surface 15 by measuring the electrostatic charge of the particles. Further, the force exerted by the material flow to the measuring surface 15 is measured. The determined velocities and forces are then processed in order to calculate the mass flow of the fluent particles.

1. A mass flow meter (1) for measuring the mass flow of a material supply flow of fluent particles, the mass flow meter (1) comprising
means (2) for receiving the material supply flow and
material conducting means (4) for conducting the material supply flow from the receiving means (2) towards an outlet (6) for discarding the material, wherein the material conducting means (4) comprise at least one guiding unit (9) having a width for conducting the material flow through the mass flow meter (1) along at least one flow direction (8), wherein the at least one guiding unit (9) comprises at least one measuring unit (20) with a measuring surface (15) having a mean slope (13) in relation to a horizontal (16) and comprising velocity measuring means (10) for determining a velocity with which the material flow is flowing over the measuring surface (15) from an upper part towards a lower part of the measuring surface (15) and force measuring means (5) for determining a force exerted by the material flow to the measuring surface (15) when flowing over the measuring surface,
the mass flow meter further comprising a processor for calculating the mass flow by processing the determined material velocities and forces,
the velocity measuring means (10) comprising at least a first and a second sensor placed at a distance (17) from each other in flow direction (8) of the material, the first (11) and second sensor (12) each being provided for gathering data on electrostatic charge of the material flow, as a function of time,
the mass flow meter (1) comprising a processor for converting the data on the electrostatic charge as a function of time to an output signal representing the velocity with which the material flow is flowing over the measuring surface
characterised in that the measuring surface (15) is curved in the flow direction (8) of the material.

2. A mass flow meter (1) according to claim 1, characterised in that the at least one force measuring means (5) is provided to determine a component of the force exerted onto the measuring surface (15) which extends perpendicular to the mean slope (13) of the measuring surface (15).

3. A mass flow meter (1) according to claim 1, characterised in that at least one measuring surface (15) has an arcuate shape with a constant radius (19).

4. A mass flow meter (1) according to claim 1, characterised in that the mass flow meter (1) comprises means (21) for adjusting the mean slope (13) of the measuring surface (15).

5. A mass flow meter (1) according to claim 1, characterised in that the mass flow meter (1) comprises means for determining the mean slope (13) of the measuring surface (15).

6. A mass flow meter (1) according to claim 1, comprising a plurality of measuring units (20) positioned symmetrical with respect to the material receiving means (2).

7. A mass flow meter (1) according to claim 6, characterised in that the mass flow meter (1) comprises multiple guiding units (9) which are substantially identical and which divide the material flow of the fluent particles in several flow directions (8), one flow direction (8) per guiding unit (9).

8. A mass flow meter (1) according to claim 6, characterised in that the plurality of measuring units (20) are identical.

9. A mass flow meter (1) according to claim 1, characterised in that the material conducting means (4) comprise means for evenly distributing the material flow over the width of the guiding unit (9).

10. A mass flow meter (1) according to claim 1, characterised in that the means for receiving the material supply flow comprise a flow controller for controlling the material supply flow.

11. A mass flow meter (1) according to claim 10, characterised in that the flow controller comprises a plurality of slideable plates (3) which when slid together decrease the mass flow of the fluent particles and which when slid away from each other increase the mass flow of the fluent particles.

12. A mass flow meter (1) according to claim 1, characterised in that at least three sensors are provided in the measuring surface (15) and in that the acceleration of the fluent particles over the measuring surface (15) is measured.

13. A process for measuring the mass flow of a material supply flow of fluent particles by providing the material supply flow to a mass flow meter (1) according to claim 1, wherein the fluent particles are fed to the mass flow meter (1) and flow along material conducting means (4) comprising at least one guiding unit (9) for guiding the flow of fluent particles along at least one flow direction (8) over a measuring surface (15) along a measuring unit (20) towards an outlet (6), wherein the velocity with which the material flow of the fluent particles flows over the measuring surface (15) is measured as well as the force exerted by the material flow to the measuring surface (15), whereafter the determined velocities and forces are processed in order to calculate the mass flow of the fluent particles, in which the velocity is determined by gathering data on the electrostatic charge of the material flow as a function of time and in which the data on the electrostatic charge as a function of time is converted to a signal representing the velocity with which the material flow is flowing over the measuring surface (15), characterised in that at least one measuring surface (15) is curved in the flow direction (8) of the material.
